(19) United States
(12) Patent Application Publication
(10) Pub. No.: US 2012/0145481 A1
(43) Pub. Date: Jun. 14, 2012

(54) Fall Arrest System Safety Device

(75) Inventor: Owain Jones, Devizes (GB)

(73) Assignee: Latchways Plc, Devizes (GB)

(21) Appl. No.: 13/146,013

(22) PCT Filed: Feb. 18, 2010
(86) PCT No.: PCT/GB10/00288

§ 371 Date: Sep. 14, 2011

(30) Foreign Application Priority Data
Feb. 20, 2009 (GB) 0902957.0

(51) Int. Cl. A62B 1/10; A62B 1/08

(52) U.S. Cl. 182/231

(57) ABSTRACT

A safety device, such as a safety block, for use in a fall arrest system, has an exit arrangement for the safety line exiting the device; the exit arrangement being arranged to permit the safety line to exit the device over a range of different exit positions. The exit arrangement may be in the form of an elongate slot. When the safety line rewinds into the line drum, the position at which the line exits the slot may move along the slot.

The present invention relates to a fall arrest system safety device and in particular to a device including a drum upon which a safety line is used, typically including an energy absorber arrangement to absorb the energy of a fall arrest event.

Fall arrest systems are used to prevent personnel working at height from suffering injury as a result of falling. Fall arrest systems are often referred to as height safety systems or fall prevention systems. Frequently such systems include a so called safety block arranged to be suspended overhead from an anchor structure. Such arrangements typically include a drum upon which a safety line is wound; a speed responsive mechanism arranged to inhibit the drum rotation above a predetermined rotational speed and an energy absorber device arranged to be activated if a load above a predetermined threshold is deployed when the speed responsive mechanism is deployed. The energy absorber devices are typically either friction brake devices or plastically deformable metallic strip arrangements that are plastically deformed during deployment in order to absorb energy.

An improved arrangement has now been devised.

According to a first aspect, the present invention provides a safety device for use in a fall arrest system, the safety device comprising:
a safety line drum mounted for rotation and upon which a safety line is to be wound;
an exit arrangement for the safety line exiting the device; wherein the exit arrangement is arranged to permit the safety line to exit the device over a range of different exit positions.

It is preferred that the safety device further comprises an attachment device for attaching the safety device to a support structure. Beneficially, the attachment device comprises a suspension device positioned in the region of an upper portion of the safety device and from which the safety device may be suspended.

The invention is particularly suited for devices in which a rewinding or re-spooling mechanism is provided, arranged to act to rotate the drum to rewind the safety line onto the drum in the absence of sufficient tension in the safety line to pay out the line.

Beneficially the device further comprises an energy absorber device arranged to be deployed upon the application of a predetermined tension in the safety line to absorb energy applied to the line.

It is preferred that the safety device further comprises a speed responsive engagement mechanism responsive to the speed of rotation of the drum, which is activated above a predetermined rotational speed of the drum to engage the drum (or a component connected to the drum) in order to inhibit rotation of the drum.

In one embodiment, the exit arrangement may beneficially comprise an elongate slot. The elongate slot preferably extends from a lower end to an upper end. In a preferred embodiment, the elongate slot preferably extends in an arcuate manner from a lower end of the slot to an upper end of the slot.

Where the device includes a suspension device positioned in the region of an upper portion of the safety device and from which the safety device may be suspended, the slot is preferably positioned predominantly to one side of the safety device (when suspended from the suspension device).

Beneficially the slot serves as a guide to raise the exit position of the safety line as the end of the safety line is retracted into the device. The safety line may include a mounted stop element such as a sheath or bob element for this purpose.

In one or more embodiments a line guide element may beneficially be mounted to be slidably retained with respect to the slot, and provide a guide through which the line can pass through the exit arrangement. In such an embodiment, it may be preferred that the slidably mounted line guide element includes a line guide aperture through which the safety line is arranged to pass.

According to a further aspect, the safety line device includes a suspension device positioned in the region of an upper portion of the safety device and from which the safety device may be suspended, the exit arrangement permitting the line to exit at a plurality of exit positions at a side of the device.

According to a further aspect, the invention provides a safety device for use in a fall arrest system, the safety device comprising:
a safety line drum mounted for rotation and upon which a safety line is to be wound;
a rewinding mechanism arranged to act to rotate the drum to rewind the safety line onto the drum in the absence of sufficient tension in the safety line to pay out the line;
an exit arrangement for the safety line exiting the device; wherein the exit arrangement comprises an elongate slot and as the rewinding mechanism rewinds the safety line into the device toward its maximum extent the position at which the safety line exits the slot moves along the slot.

The invention will now be further described by way of example only and with reference to the accompanying drawings, in which:

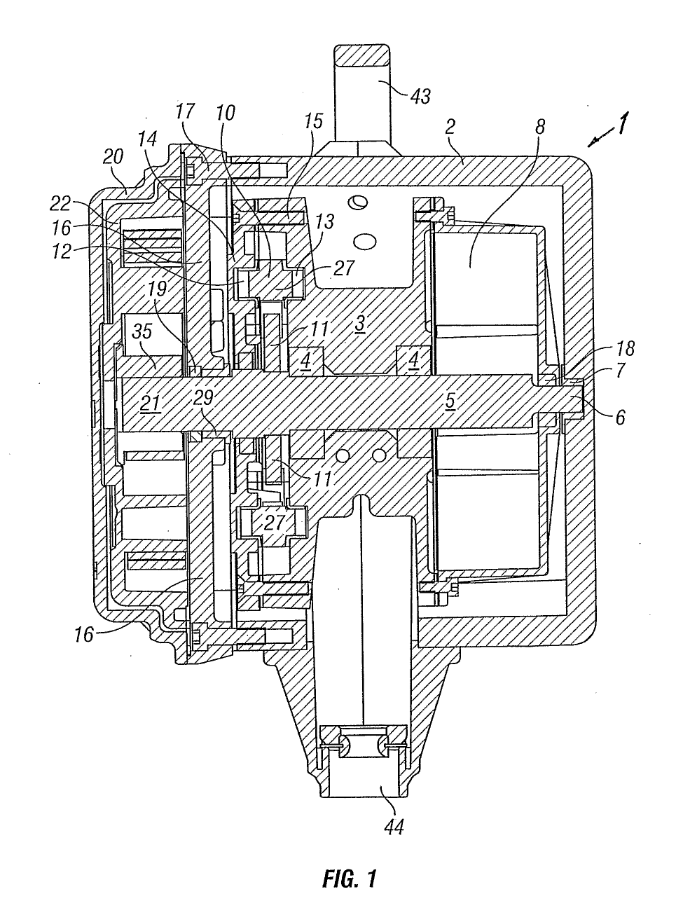

FIG. 1 is a schematic sectional view of a first embodiment of fall arrest system safety device falling outside the scope of the invention, but shown for exemplary purposes;

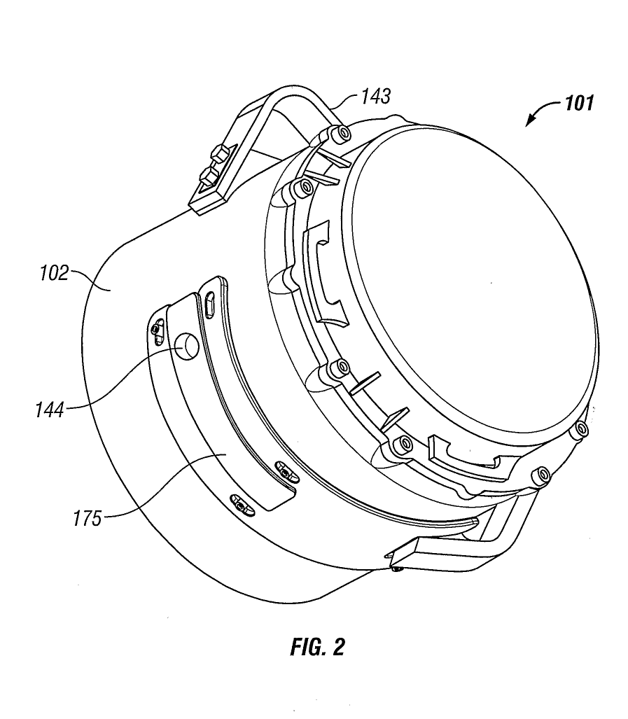

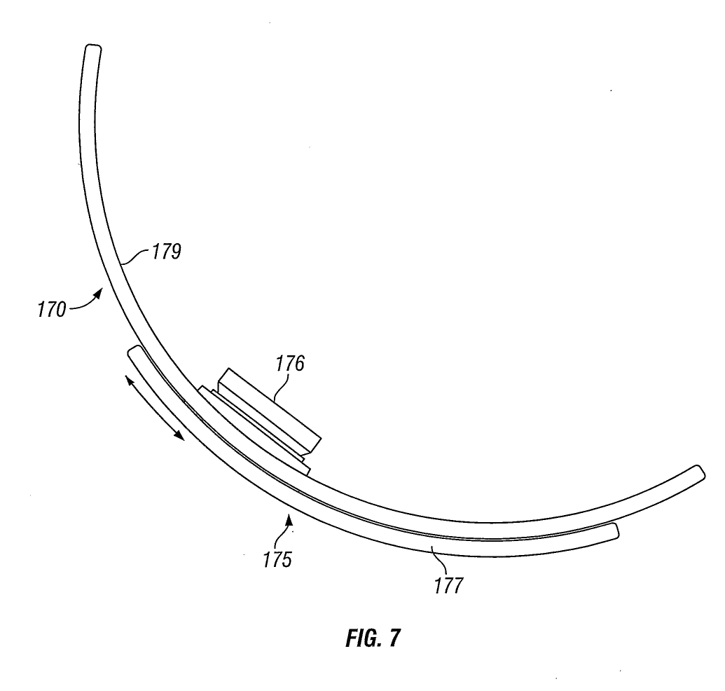

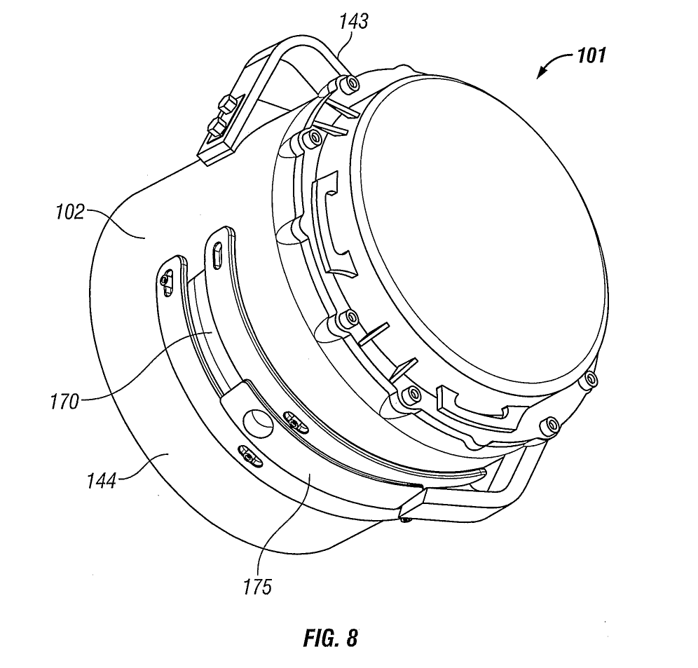

FIGS. 2 to 8 are schematic views of a first exemplary device in accordance with the present invention;

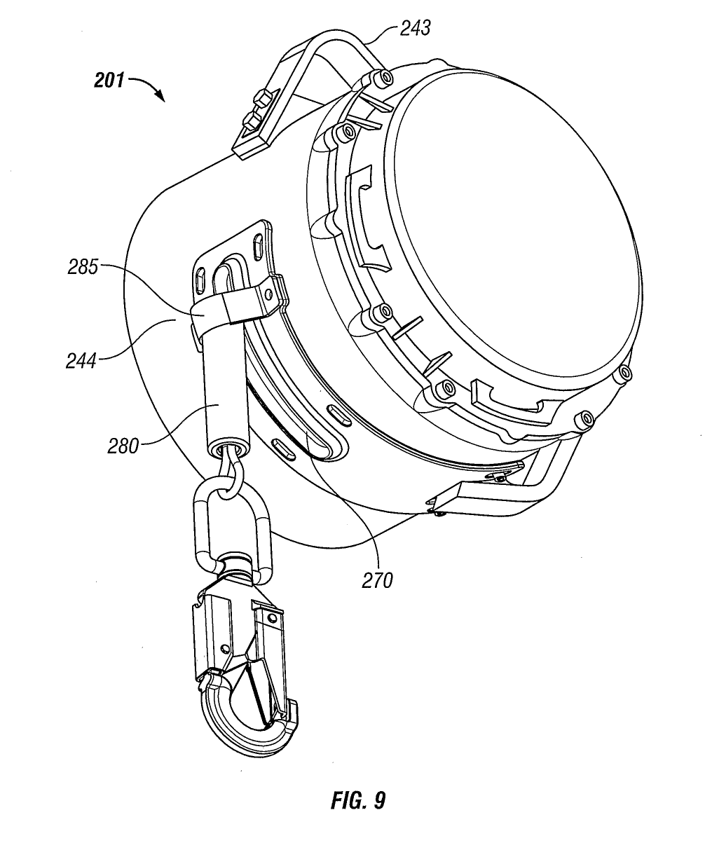

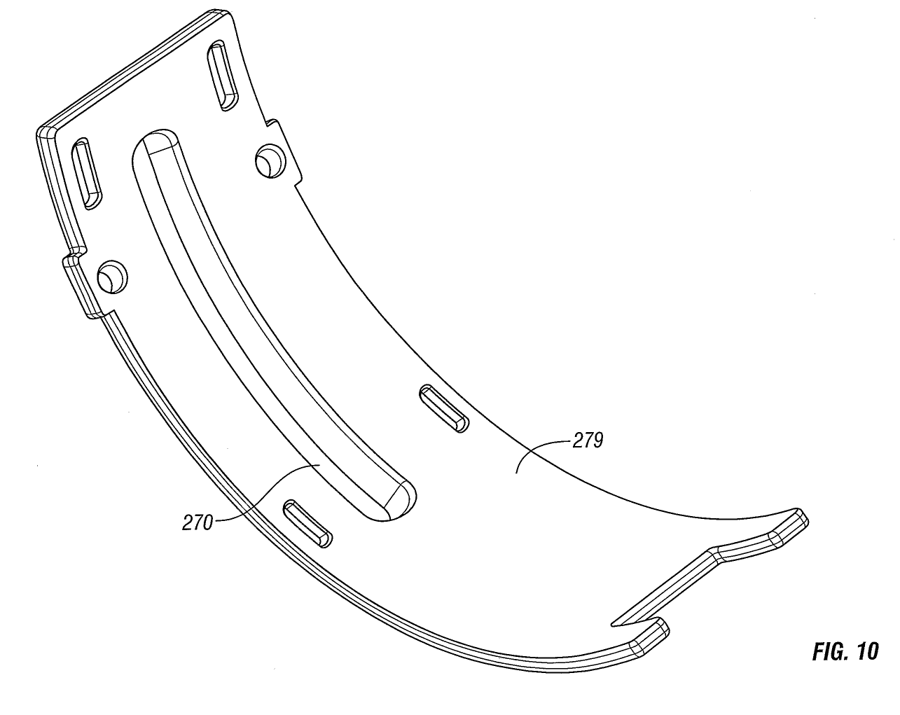

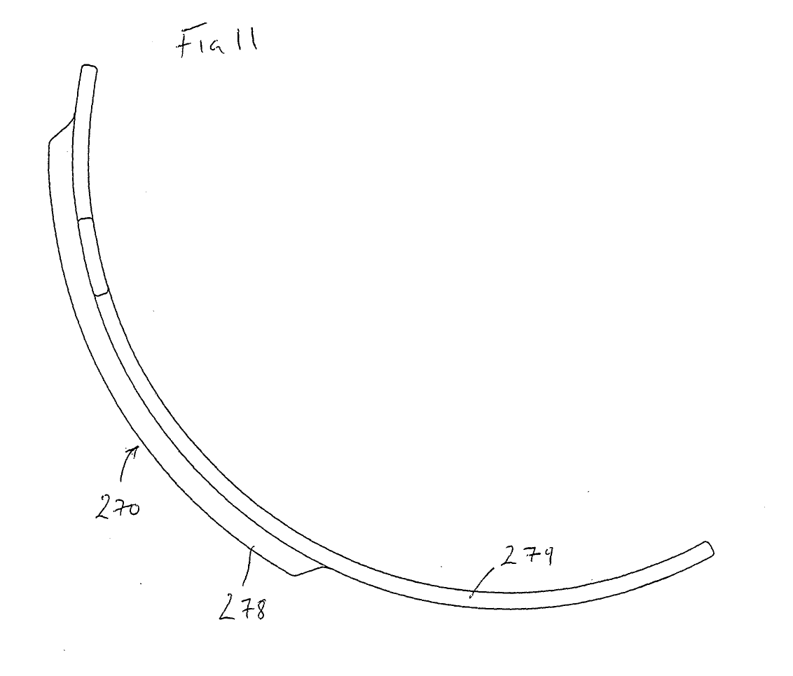

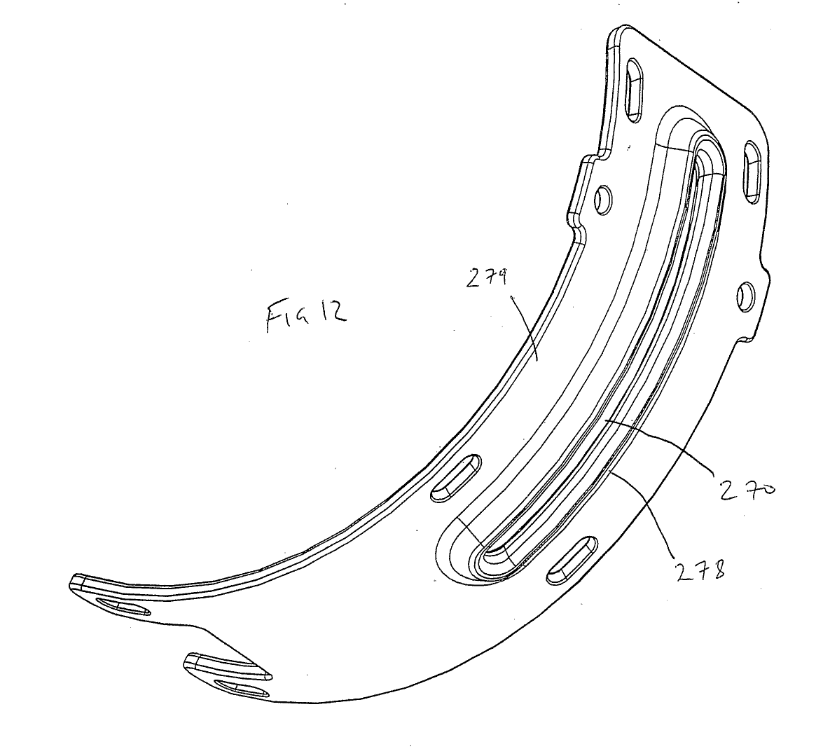

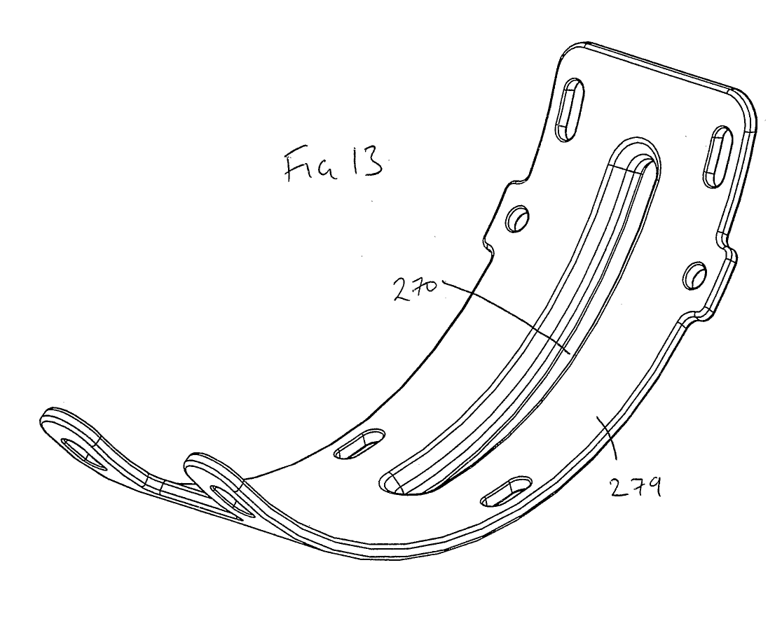

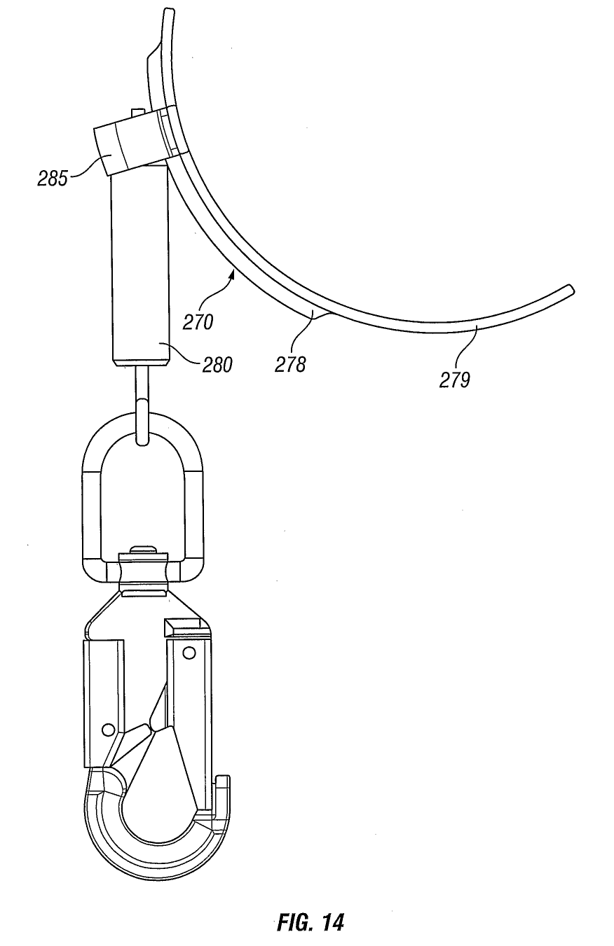

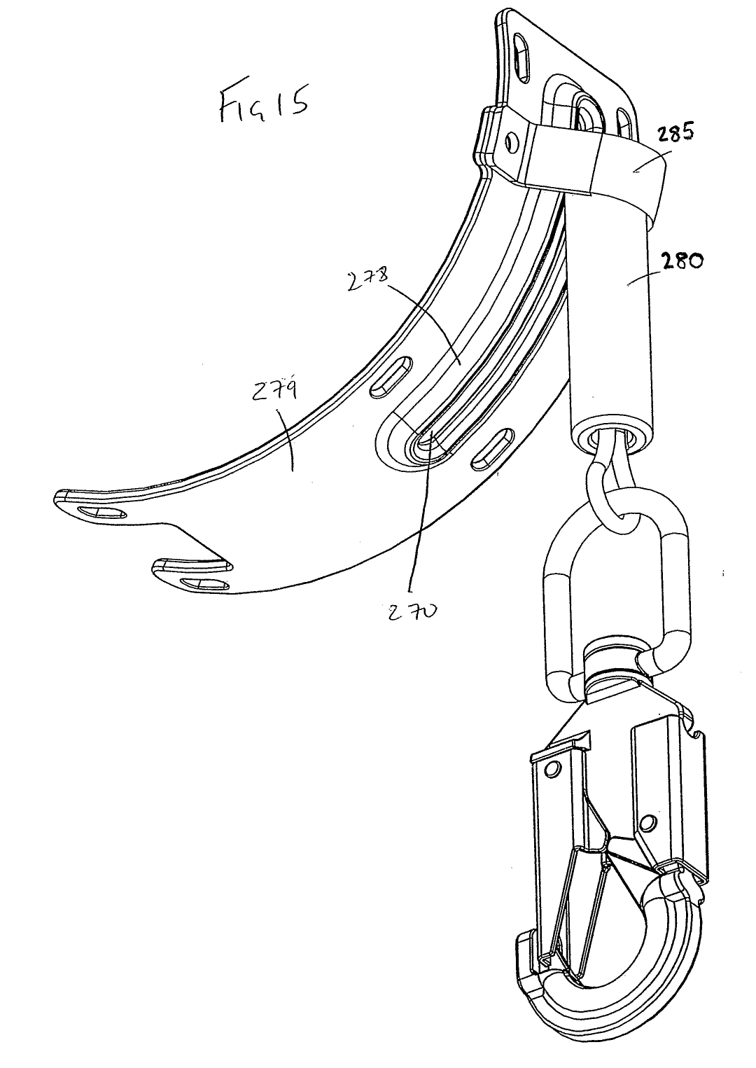

FIGS. 9 to 15 are schematic views of a second exemplary device in accordance with the present invention.

Referring to the drawings, and initially to FIG. 1, there is shown a safety device which falls outside the scope of the invention but serves to disclose the structure and operation of a fall arrest safety device to which the present invention may be applied to beneficially modify the operation of the device in a beneficial manner. FIG. 1 discloses a safety device (or safety block) having a main housing 2 within which is mounted a shaft 5 and a rotary drum 3 mounted to be able to rotate about the shaft by means of bearings 4. The device includes an attachment eye 43 for suspension from an anchor structure as is known for prior art safety block devices. A safety line wound on the drum passes out of the device via an exit portion 44. It is important to note that in this embodiment the device is shaped, configured an arranged such that safety line exit 44 is positioned directly below the attachment eye 43 when the device is suspended from the anchor structure.

Within the main housing 2 adjacent and connected to the rotary drum 3 is a rewinding or re-spooling mechanism 8. When a length of safety line is played out from the drum (causing rotation of the drum 3) the rewinding mechanism applies a small torque to the drum 3 causing it to contra-rotate in a direction which tends to rewind the safety line back onto the drum. One preferred type of rewinding mechanism is a coiled spring of the clockspring type. Many suitable rewinding mechanisms are known in the art and will therefore not be described in detail herein. The rewinding mechanism is provided with a shaft bearing 18. A reduced diameter proximal end 6 of the shaft 5 is held in a tail bearing 7 in the side of the main housing 2.

Also coupled to the drum at its other side, is a speed responsive engagement arrangement, comprising a pawl 10 and ratchet 11 arrangement. The pawl and ratchet arrangement may for example be of a type as described in WO2008/007119. The pawls 10 are mounted for rotation with the drum 3 by means of a pivoting boss 27 that is received in a respective boss recess 12, 13 provided in the drum 3 and a facing plate 14 which is fixed to the rotary drum 3 by means of securing bolts 15. The ratchet plate 11 is secured for rotation with the shaft 5. At speeds of rotation of the drum below a predetermined rate the safety line is able to pay out from the drum unabated. In this regime, the pawls 10 rotate with the drum 3 and do not engage the ratchet 11 teeth formations. The ratchet 11 remains fixed to the shaft 5 and the shaft 5 and ratchet 11 do note rotate with the drum 3.

The main housing 2 is closed by an end plate 16 which is bolted to the main housing 2 by means of bolts 17. The distal end 21 of the shaft 5 extends through a bush 29 secured in an axial aperture in the facing plate 16 the bush permits rotation of the shaft 5 with respect to the facing plate 16 and main housing 2. The distal end of the shaft is D shaped in section, having a flat 28 in order to enable a keying engagement connection with a connecting coiler member of an energy absorber as will be described. A shaft seal 19 seals the shaft 5. This arrangement ensures that the interior of the main housing 2 is sealed from the exterior environment of the device, even thought the shaft extends through the facing plate 16 which acts as a dividing wall.

An energy absorber housing 20 is bolted to the main housing 2 and contains an energy absorber cartridge 22 containing an energy absorber strip 23. The energy absorber strip 23 is loaded into the cartridge 22 in un-deployed coiled form. When deployed during a fall arrest event the energy absorber strip is deployed to a deformed state in order to absorb the energy of a fall. The energy absorber strip 23 is arranged to absorb energy in response to relative rotational movement of the shaft 5 and coupled coiler member 35 with respect to a deformer ring. The energy absorber strip comprises a stainless steel strip 23 having a constant thickness and width along its entire length. In operation, the energy absorber absorbs energy by plastic deformation of the stainless steel strip 23. The absorber cartridge 22 is secured by means of bolts to the facing plate 16 of the main housing and provides protection against environmental effects such as weathering or dust. Other absorber arrangements may be utilised, such as a friction brake or clutch type energy absorber.

In a fall arrest event the safety line pays out from the drum 3 at a higher speed than in normal ‘safe’ pay out situations. Upon the drum 3 rotational speed reaching a predetermined threshold, the ratchet 11 causes the pawl 10 to kick out to a degree such that the pivotally mounted pawls 10 pivot about their pivot bosses 27 beyond a tipping point and become orientated to an engagement position in which the pawl 10 engages with the teeth of the ratchet 11. This is described in detail in WO2008/007119 but in the arrangement described in that document the pawls are fixed with respect to the safety line drum and the ratchet rotates with the safety line drum which is the reverse of the situation described herein. In the teeth engaged position, the drum 3 is effectively coupled to the shaft 5 by means of the pawl 10 engagement with the ratchet 11. Further rotation of the drum 3 therefore causes coupled rotation of the shaft 5 (and the drum 3) in the same direction. Also, the end 21 of the shaft 5 is drivingly coupled to the coiler member 35, which is therefore caused to rotate relative to the deformer ring 33. This relative rotation will wind the stainless steel strip 34 around the coiler member 5 and pull the stainless steel strip 34, coiled in the annular strip storage channel 37, through a slot in the deformer and into the annular space 38. As the strip 34 passes through the slot, the strip 34 is plastically deformed and so absorbs energy.

Following deployment of the energy absorber as a result of a fall arrest event, the energy absorber can be replaced by means of removing the absorber casing 21, removing the spent cartridge 22, replacing the cartridge by fitting a replacement cartridge and re-securing in position the absorber casing 21. All of this can be achieved without disturbing any other working components of the device which remain sealed off in the main housing 2 closed by the face plate 16 acting as a dividing wall through which the shaft end 21 extends.

A technical performance issue that arises in respect of this embodiment of device occurs because the device is shaped, configured an arranged such that the safety line exit 44 is positioned directly below the attachment eye 43 when the device is suspended from the anchor structure by the attachment eye. Because of this a high degree of friction between the safety line and the exit occurs as the line is payed out from the device (by normal movement of the user connected to the end of the safety line), or retracted back into the device (by means of the recoiler spring). This friction can be reduced by permitting the safety line to exit the device, not at an exit positioned directly below the attachment point in normal balanced suspension, but at a side exit on the side at which the line uncoils from the drum.

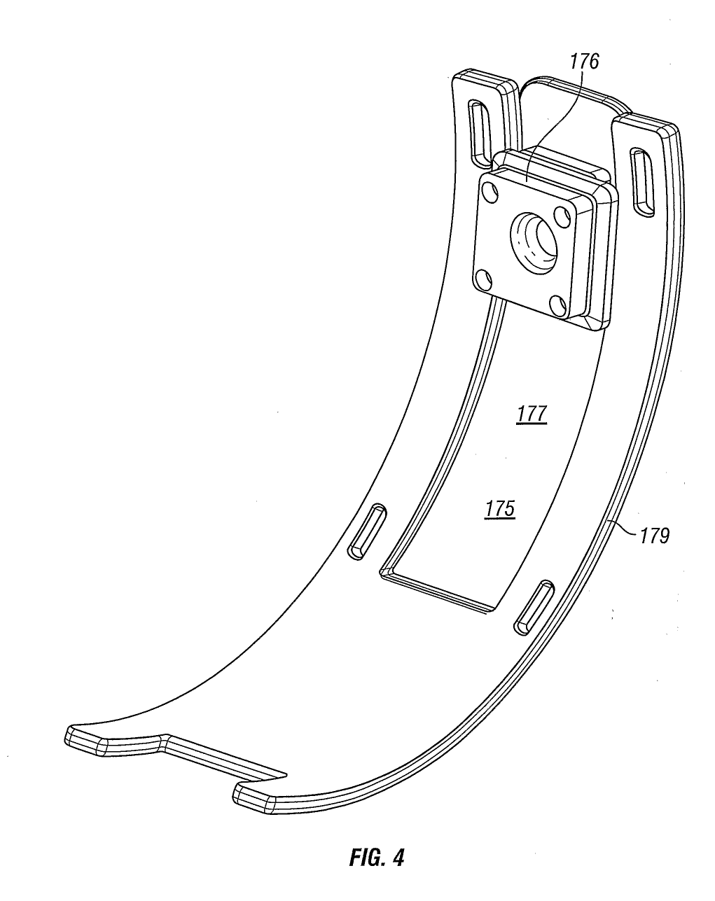

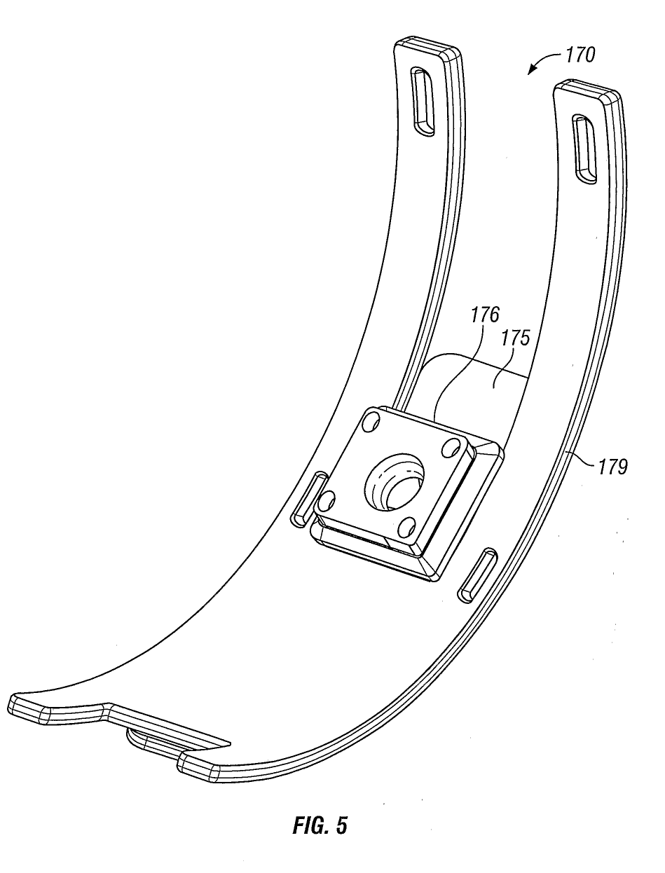

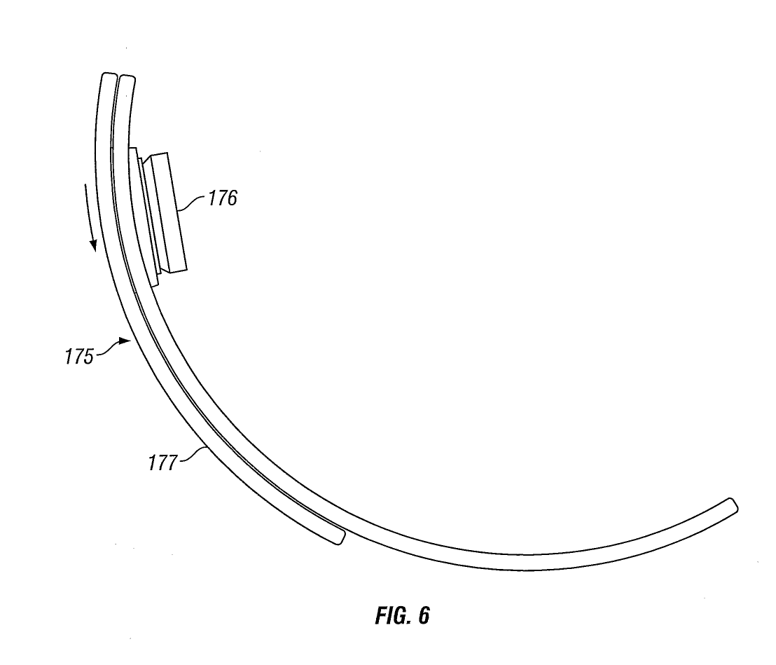

Such an arrangement forms a technical characteristic of the invention and an embodiment of such a safety block device 101 is shown in FIGS. 2 to 8. In this embodiment a suspension attachment eyelet 143 is positioned at the top of the device housing 102 and provides an attachment means for suspension of the device from an anchor structure. The device is such that, when balanced suspended from the eyelet 143 under the influence of its own weight and no applied load, the exit arrangement 144 for the line 154 to exit the housing 102 is positioned to the side of the housing and not directly below the attachment eyelet 143. The exit arrangement 144 comprises an arcuate slot 170, provided in an arcuate cover plate 179, extending for a length about the periphery of the housing 102 of the device. Within the slot is mounted a slider 175 which has a apertured line guide 176 and a cover portion 177 extending arcuately away from the slot. The slider is formed with a pair of flanges for overlapping with the edges for the slot 170, ensuring that the slider 175 is retained by the slot in a sliding relationship. The relationship between the slider 175 and the slot is shown most clearly in FIGS. 4 to 7. In the configuration shown in FIGS. 4 and 6 the slider 175 is positioned at the uppermost position with respect to the slot 170, and the slot is largely covered by the cover portion 177. In the configuration shown in FIGS. 5,7 and 8, the slider 175 is positioned at its lowermost position and the slot 170 is, to a large extent, exposed.

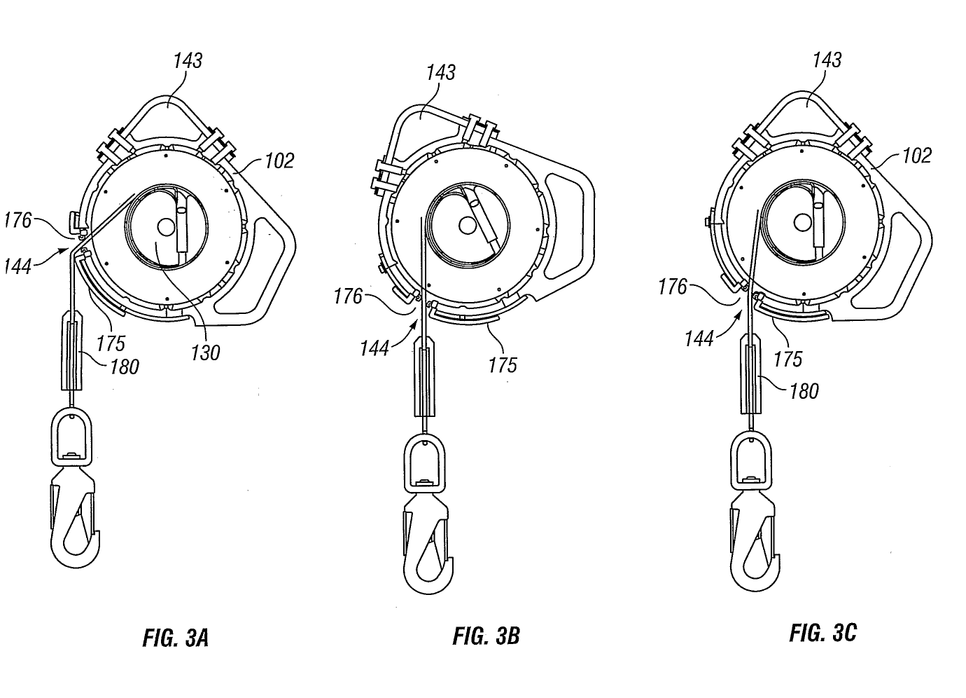

In a normal at rest configuration before being attached to a user, the condition of the device is as generally shown in FIG. 3A. In this configuration, the device is suspended from the eyelet 143 and the device is balanced such that the axis of the drum 103 on which the line is wound is positioned directly below the suspension eyelet 143. In this configuration the clockspring re-spooling mechanism 8 rewinds the drum to its maximum extent rewinding the lifeline into the housing 102. The bob sheath 180 on the end of the housing will engage with the slider 175 about the guide aperture 176 and draw the slider upwardly to its uppermost extent under the influence of the clockspring re-spooling mechanism 8.

When the line is attached to the user the line will be payed out from the housing as the user moves away from the housing and the drum rotates on its axis. Depending upon the direction in which the user moves and the angle the line is payed out at, the slider 175 will move upwardly or downwardly along the slot 170 to a rest or equilibrium position. Unless the end limit of the slot 170 is reached in either direction, no turning moment will be applied to the device which will remain with the axis of the drum 103 positioned directly below the suspension eyelet 143. This is the situation shown in FIG. 3C.

In the event of a fall arrest occurring, the rotation of the drum 103 is arrested as described earlier in this document. The load applied by the line is then transmitted to apply a turning moment or torque to the device causing the device to re-orientate itself such that the now taught lifeline extends downwardly from directly below the suspension point of the suspension eyelet 143. This is the configuration shown in FIG. 3B. The system of the present invention enables this configuration to be adopted and further swinging of the lifeline from side to side to occur without the housing 102 needing to sway in a side to side manner, because the lifeline can swing in the slot 170, simply moving the slider 175 from side to side in the slot 170. In this way the loading of the lifeline exit from the housing is reduced or avoided, particularly in a fall arrest event. Unlike a fixed exit, in the event of a fall, the device can effectively move independently of the exit arrangement thus limiting jarring effect for the user.

In normal use, the exit arrangement 144 moves to a position of least resistance to retraction and paying out of the lifeline which reduces wear on the lifeline and the exit arrangement aperture considerably.

A second embodiment of device in accordance with the invention is shown in FIGS. 9 to 15. In this embodiment, the device 201 is generally similar to the device of FIGS. 2 to 8 but the exit arrangement 244 includes an arcuate slot 270 (provided in arcuate plate 279) but no slider is required. An upstanding outwardly projecting peripheral lip 278 defines the edges of the slot 270. As is the case for the embodiment of FIGS. 2 to 8, the guide slot 270 is positioned to extend to provide an exit facility to the side of a line between the suspension eye 243 and the axis of the drum upon which the lifeline is wound. Indeed, as before the slot provides an exit facility to the side of the drum rather than directly below it. In a normal at rest configuration before being attached to a user, the condition of the device is as generally shown in FIG. 9. In this configuration, the device is suspended from the eyelet 243 and the device is balanced such that the axis of the drum 103 on which the line is wound is positioned directly below the suspension eyelet 243. In this configuration, in the absence of any applied load acting on the lifeline, the clockspring re-spooling mechanism 8 rewinds the drum to its maximum extent, rewinding the lifeline into the housing 202 and onto the drum 8. The bob sheath 280 on the end of the housing will engage with the slot 270 and be guided upwardly along the slot to its uppermost limit under the influence of the clockspring re-spooling mechanism 8, until it locates in the docking collar 285 provided at the top of the slot.

The device has primarily been described in an embodiment in which the device is suspended from an attachment eyelet and the line extends downwardly. It should be realised however that the benefit of the invention will realised by use in other orientations such as where the lifeline is deployed horizontally.

1. A safety device for use in a fall arrest system, the safety device comprising:
a safety line drum mounted for rotation and upon which a safety line is to be wound; and
an exit arrangement for the safety line exiting the device;
wherein the exit arrangement is arranged to permit the safety line to exit the device over a range of different exit positions.

2. A safety device according to claim 1 further comprising an attachment device for attaching the safety device to a support structure.

3. A safety device according to claim 2, wherein the attachment device comprises a suspension device positioned in a region of an upper portion of the safety device and from which the safety device may be suspended.

4. A safety device according to claim 1 further comprising a rewinding or re-spooling mechanism arranged to act to rotate the safety line drum to rewind the safety line onto the safety line drum in the absence of sufficient tension in the safety line to pay out the safety line.

5. A safety device according to claim 1 further comprising an energy absorber device arranged to be deployed upon the application of a predetermined tension in the safety line to absorb energy applied to the safety line.

6. A safety device according to claim 1 further comprising a speed responsive engagement mechanism responsive to the speed of rotation of the safety line drum, which is activated above a predetermined rotational speed of the safety line drum to engage the safety line drum in order to inhibit rotation of the safety line drum.

7. A safety device according to claim 1, wherein the exit arrangement comprises an elongate slot.

8. A safety device according to claim 7, wherein the elongate slot extends from a lower end to an upper end.

9. A safety device according to claim 7, wherein the elongate slot extends in an arcuate manner from a lower end to an upper end.

10. A safety device according to claim 7 further comprising a suspension device positioned in the region of an upper portion of the safety device and from which the safety device may be suspended, the elongate slot being positioned to one side of the device when suspended from the suspension device.

11. A safety device according to claim 7, wherein the elongate slot serves as a guide to raise the exit position of the safety line as an end of the safety line is retracted into the device.

12. A safety device according to claim 7 further comprising a line guide element slidably retained with respect to the elongate slot.

13. A safety device according to claim 12, wherein the line guide element includes a line guide aperture through which the safety line is arranged to pass.

14. A safety device according to any preceding claim 3, the exit arrangement permitting the safety line to exit at a plurality of exit positions at a side of the device.

15. A safety device for use in a fall arrest system, the safety device comprising:
a safety line drum mounted for rotation and upon which a safety line is to be wound;
a rewinding mechanism arranged to act to rotate the safety line drum to rewind the safety line onto the safety line drum in the absence of sufficient tension in the safety line to pay out the safety line; and
an exit arrangement for the safety line exiting the device; wherein the exit arrangement comprises an elongate slot, and as the rewinding mechanism rewinds the safety line into the device toward its maximum extent, the position at which the safety line exits the elongate slot moves along the elongate slot.

16. A safety device according to claim 1 further comprising a speed responsive engagement mechanism responsive to the speed of rotation of the safety line drum, which is activated above a predetermined rotational speed of the safety line drum to engage a component connected to the safety line drum in order to inhibit rotation of the safety line drum.
